(19) United States
(12) Patent Application Publication
(10) Pub. No.: US 2007/0237910 A1
(43) Pub. Date: Oct. 11, 2007

(54) Media sheet

(76) Inventors: Xiaoqi Zhou, San Diego, CA (US); Hai Quang Tran, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/399,767

(22) Filed: Apr. 7, 2006

(51) Int. Cl. B32B 9/00; B32B 5/16; B41M 5/50

(52) U.S. Cl. 428/32.34; 428/484.1

(57) ABSTRACT

A media sheet has a first layer formed on a substrate and a second layer formed on the first layer. The first layer includes inorganic pigments, and the second layer includes a plurality of wax particles.

### BACKGROUND

Color photographic printing, e.g., using liquid or dry toner electrophotographic-imaging devices, such as laser printers, is becoming increasingly popular. However, with conventional photographic paper, it is often difficult to obtain a high-gloss appearance, such as in traditional silver-halide photographic printing. Electrophotographic printers are usually equipped with single or double heated fuser roller to fix an image, making it difficult obtain a consistent gloss level before and after fusing due to a rather low thermal stability of some conventional photographic paper.

### DESCRIPTION OF THE DRAWINGS

FIG. 1 is a cross-sectional view of a media sheet, according to an embodiment of the invention.

### DETAILED DESCRIPTION

In the following detailed description of the present embodiments, reference is made to the accompanying drawings that form a part hereof, and in which are shown by way of illustration specific embodiments that may be practiced. These embodiments are described in sufficient detail to enable those skilled in the art to practice disclosed subject matter, and it is to be understood that other embodiments may be utilized and that process, electrical or mechanical changes may be made without departing from the scope of the claimed subject matter. The following detailed description is, therefore, not to be taken in a limiting sense, and the scope of the claimed subject matter is defined only by the appended claims and equivalents thereof.

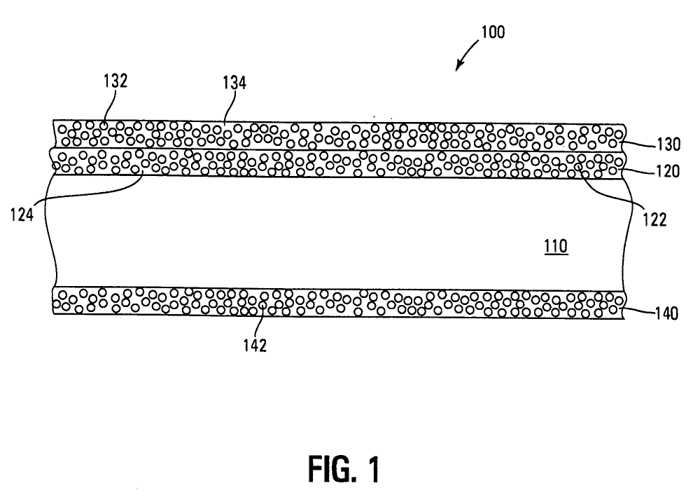

FIG. 1 is a cross-sectional view of a media sheet 100, such as a photographic-grade media sheet, e.g., suitable for use in a color electrophotographic-imaging device, according to an embodiment. Media sheet 100 includes a substrate 110, such as a polymeric film, polymer film co-extruded paper stock, fabric paper stock, or the like. For one embodiment, substrate 110 has a basis weight of about 60 to about 300 gram/m². For another embodiment, the substrate 110 has a basis weight of about 80 to about 200 gram/m².

For one embodiment, exemplary pulps used in the manufacture of substrate 110 include, but are not limited to, ground-wood pulp, sulfite pulp, chemically ground pulp, refiner-ground pulp, thermo-mechanical pulp, or various mixtures thereof. For some embodiments, fillers may be incorporated into the pulp to control physical properties of media sheet 100. Exemplary fillers include, but are not limited to, ground calcium carbonate, precipitated calcium carbonate, titanium dioxide, kaolin clay, silicates, etc. For other embodiments, the amount of filler incorporated in substrate 110 is about 5 to about 20 percent by weight, while for one embodiment the amount of filler incorporated in substrate 110 is about 5 to about 15 percent by weight.

Substrate 110 may include an internal sizing agent for some embodiments. This acts increase internal bond strength of fibers of substrate 110 as well as to control the stiffness of media sheet 100. Examples of suitable internal sizing agents include rosin-based sizing agent, synthetic sizing agent, petroleum-resin-based sizing agent, and neutral sizing agent.

A pigment-containing layer 120 is formed on substrate 110, as shown in FIG. 1. Although pigment-containing layer 120 is shown on an upper surface (relative to FIG. 1) of substrate 110, for another embodiment, a pigment-containing layer 120 may be formed on both the upper surface of substrate 110 and the opposing (or lower) surface of substrate 110. For some embodiments, additional coatings or layers, such as anti-curl layers and antistatic layers may be formed on pigment-containing layer 120.

For one embodiment, pigment-containing layer 120 includes inorganic pigments 122, such as titanium dioxide, hydrated alumina, calcium carbonate, barium sulfate, silica, kaolin clays, zinc oxide, etc., and a binder 124. The inorganic pigments 122 can be used in the forms of either dry powder or pre-dispersed slurry or combination of both. For one embodiment, binder 124 may include inorganic or inorganic compounds that act to supply adhesion force to adhere inorganic pigments 122 to each other and to substrate 110. Examples of binder 124 include, but not limited to, a water-soluble polymer and a water dispensable polymeric latex having micron or submicron organic particles, etc. Examples of suitable water-soluble polymers include, but are not limited to, polyvinyl alcohol, starch derivatives, gelatin, cellulose derivatives, acrylamide polymers. Examples of suitable water-dispensable polymers include, but are not limited to acrylic polymers or copolymers, vinyl acetate latex, polyesters, vinylidene chloride latex, styrene-butadiene or acrylonitrile-butadiene copolymers. For another embodiment, pigment-containing layer 120 includes about 70 dry parts to about 100 dry parts of inorganic pigments 122 based on the total dry weight (excluding all evaporable components such as water) of pigment-containing layer 120. For another embodiment, the inorganic pigments 122 are powder particles that are adhered to each other and to substrate 110 using binder 124. For one embodiment, pigment-containing layer 120 includes about 5 to about 15 parts of binder 124 based on the total dry weight of pigment 122, while for another embodiment pigment-containing layer 120 includes about 8 to about 10 parts of-binder 124 based on the total dry weight of pigment 122.

Optionally, for one embodiment, pigment-containing layer 120 may also include an antistatic agent(s). Examples of suitable antistatic agents include metal oxides, such as zinc oxide, tin oxide, indium tin-oxide, silicon-dioxide tin-oxide, antimony tin-oxide, titanium tin-oxide, inorganic and polymeric electrolytes, such as sodium chloride, potassium chloride, sodium sulfate, potassium sulfate, quaternary ammonium salts, polymeric electrolytes, sodium salts of polystyrene sulfonates, ammonium salts of polystyrene sulfonates, sodium salts of polyacrylates, ammonium salts of polyacrylates, sodium salts of polymethacrylates, ammonium salts of polymethacrylates, sodium salts of polyvinyl sulfonates, ammonium salts of polyvinyl sulfonates, sodium salts of polyvinyl phosphates, ammonium salts of polyvinyl phosphates, and/or combinations thereof. Alternatively, in another embodiment, the antistatic agent(s) may be applied as a separate coating on pigment-containing layer 120.

Optionally, for one embodiment, pigment-containing layer 120 may also include other functional additives. The examples of these functional additives include, but not limit to, optical brightness agent (OBA), color dye, water retaining agents, dispersants, UV absorbers, rheological control agents, deformers, PH control agents, cross-linking agent and coating lubricants.

For one embodiment, pigment-containing layer 120 is formed by coating substrate 110 with a coating that includes inorganic pigments 122 and binder 124 contained in a liquid, such as water. For one embodiment, the coating may also contain the antistatic agent(s) and/or a water-retaining agent, a color dye, and an optical brightness agent. For another embodiment, binder 124 is dissolved in the liquid. For one embodiment, pigment-containing layer 120 is formed onto substrate 110 with a coating weight of about 5 to about 15 gram/m², but preferably the coating weight of pigment-containing layer 120 is about 8 to about 12 gram/m².

For various embodiments, the coating can applied by roll-coating, conventional slot-die processing, blade coating, bent-blade coating, rod coating, shear-roll coating, reverse-roll coating, slot-die cascade coating, pond coating, curtain coating, air-knife coating, gravure coating, size-pressing coating, brushing coating, and/or other comparable methods, including those that use circulating and non-circulating coating technologies. For some embodiments, spray-coating, immersion-coating, and/or cast-coating techniques may be used.

Subsequently, pigment-containing layer 120 is dried, e.g., using infrared heating or heated air or a combination thereof. Other conventional drying methods and equipment can also be used as known in the art. After drying, coated substrate 110 has a moisture content of about 3 to about 10 percent by weight and preferably about 5 to about 7 percent by weight.

For one embodiment, substrate 110 with pigment-containing layer 120 formed thereon is passed between a pair of rollers, as part of a calendering process, after drying pigment-containing layer 120. The calendering device can be a separate super-calendering machine, an on-line, soft-nip calendering machine, an off-line, soft-nip calendering machine, or the like.

An image-receiving layer 130 is formed on pigment-containing layer 120. Image-receiving layer 130 includes wax particles 132 and a polymeric resin 134, such as a water-soluble or water-dispersible resin. For one embodiment, wax particles 132 have a melting temperature of about 50° C. to about 200° C., while for another embodiment wax particles 132 have a melting temperature of about 70° C. to about 130° C. For some embodiments, the amount of wax 132 in the image-receiving layer 130 is about 5 to about 50 percent of the dry weight of the resin 134 in the image-receiving layer 130, while for other embodiments the amount of wax 132 in the image-receiving layer 130 is about 10 to about 30 percent of the dry weight of the resin 134 in the image-receiving layer 130. Preferably, for one embodiment, the polymeric wax has a physical form of fine particles and is pre-dispersed into water or other water compatible carriers. The particles have a mean particle diameter of about 0.1 micron to about 1 micron for one embodiment or about 0.3 micron to about 0.5 micron for another embodiment.

Exemplary wax particles 132 include carnauba wax, montan wax, paraffin wax, microcrystalline waxes from the distillation of crude oil, synthetic polymers and combinations thereof. Examples of synthetic polymers include those having a polyolefin backbone structure, such as high-density polyethylene, low-density polyethylene, linear low-density polyethylene, polypropylene, and polybutene. Other examples of synthetic polymers include, ester-containing waxes, polymeric hydrohalocarbon compounds, and polymeric hydrofluoro compounds, such as polytetrafluoroethylene.

For one embodiment, resin 134 acts as a binder for binding the wax particles to each other and to pigment-containing layer 120. Resin 134 also works as continuous dispersing matrix for the wax. Any water-soluble or water-dispersible resin that has a binding capability on the order of resins conventionally used in aqueous coating compositions in paper coating may be used but preferably have a good gloss appearance when form a film. Resin 134 may be a natural or a synthetic polymeric binding material. Examples of natural binding materials include modified starch, soybean protein, and casein. Suitable synthetic polymeric binders include water-soluble polymers and polymeric emulsions, either alone or in combination. Polyvinyl alcohol and acrylamide polymers are examples of suitable water-soluble polymers. Examples of suitable polymeric emulsions include polyesters, acrylic polymers or copolymers, vinyl acetate latex, polyvinyl acetals, vinyl-alcohol-vinyl acetal copolymers, vinylidene chloride latex polycarbonates, styrene-butadiene or acrylonitrile-butadiene copolymers, copolymers containing acrylic monomers and at least one other monomer, and the like, as well as mixtures thereof. For one embodiment, preferred polymers include those having functional groups (i.e., reactive groups) in macro-molecular chains, especially on-the-side chains so that the polymers can be cross-linked using an external cross-linker or self-cross-linkable reactive groups in molecular chains during a drying procedure to control physical properties, such as heat resistance.

Further, in another embodiment, a powder with very fine particles and high reflection index, such as fine titanium dioxide powder is added into the formulation of image-receiving layer 130, to improve its optical performance.

For one embodiment, image-receiving layer 130 is formed by coating pigment-containing layer 120 with a coating that includes solid wax particles 132 and the material of resin 134 contained in a liquid, such as water. For one embodiment, wax particles 132 are dispersed in the liquid, and the material of resin 134 is dissolved in the liquid. For another embodiment the small solid particles of the material of resin 134 is dispersed in the liquid. For one embodiment, the wax-containing layer 130 is formed onto pigment-containing layer 120 with a coating weight of about 2 to about 8 gram/m², but preferably the coating weight of layer 130 is about 3 to about 5 gram/m².

For various embodiments, the coating can applied by roll-coating, conventional slot-die processing, blade coating, bent-blade coating, rod coating, shear-roll coating, reverse-roll coating, slot-die cascade coating, pond coating, curtain coating, air-knife coating, gravure coating, size-pressing coating, brushing coating, and/or other comparable methods, including those that use circulating and non-circulating coating technologies. For some embodiments, spray-coating, immersion-coating, and/or cast-coating techniques may be used. The coating is subsequently dried, e.g., using heated air dryer or infra-red dryer or a combination of both.

Image-receiving layer 130 is the outermost layer of media sheet 100. Image-receiving layer 130 receives marking material, e.g., toner, during an imaging process, e.g., during printing, from an imaging device, such as an electrophotographic-imaging device, e.g., a laser printer. During printing, the toner is fused, e.g., melted, into image-receiving layer 130 to form a hard-copy image, e.g., when heat and/or pressure are applied to media sheet 100, after media sheet 100 passes a photoconductor drum or a transfer belt of an elecrtrophotographic imaging device and received imaged toner particles onto layer 130. Not to be bonded to any theory, it is believed that the presence of the wax in image-receiving layer 130 acts to enhance the surface gloss, acts as an internal release agent to reduce the amount toner picked-up by a hot fuser roller of a printer during printing, and acts as a friction controlling agent to reduce sheet stickiness and thus the number of paper jams.

Optionally, for one embodiment, a layer 140 may be formed on substrate 110 opposite image-receiving layer 130, as shown in FIG. 1. Layer 140 may be formed directly on substrate 110 for some embodiments. Alternatively, for other embodiments, one or more or layers (not shown), such as anti-curl layers may be interposed between substrate 110 and layer 140. For one embodiment, layer 140 includes one or more inorganic pigments such as, titanium dioxide, hydrated alumina, calcium carbonate, barium sulfate, silica, kaolin clays, zinc oxide, etc, and at least a binder material, as exampled in layer 120.

For another embodiment, layer 140 includes optional particles 142, as shown in FIG. 1, that are mixed into the material of layer 140 prior to its formation on substrate 110. Particles 142 act as spacers to increase sheet separation and to reduce paper jams during printing. Examples of suitable particles 142 include inorganic glass hollow and solid micro-spheres and organic polymeric beads. For one embodiment, an average diameter of particles 142 is about 0.7 micron to about 30 microns.

For some embodiments, formation of layer 140 includes applying a liquid coating that includes the inorganic pigments dispersed in a liquid, such as water. For embodiments including particles 142, the particles 142 are also dispersed in the liquid.

Image-receiving layer 130 is a relatively “closed” layer in terms of moisture migration passing from base stock 120 to the atmosphere, so layer 140 plays an important role to prevent paper or toner blister during printing. When the media/toner combination undergoes fusing, the moisture absorbed inside the media is typically heated causing vaporization, thereby generating strong vapor pressure beneath the coating. This can be further exacerbated if the media was prepared or printing occurs under higher humidity conditions. Further, if multiple heated fuser rollers are used, or higher fusing temperatures are present to achieve high toner gloss, blistering can be even more pronounced. The open structure in layer 140 supplies an efficient pass to release moisture pressure and prevent the blister.

For various embodiments, layer 140 also acts provide the feel of silver-halide photographic paper and a surface that can be manually written on using manual writing instruments, such as pencils and pens. For some embodiments, layer 140 acts to control friction between successive media sheets and between media sheets and pick-up rollers of the printer.

Example Media Sheet

Pigment-containing layer 120 is 100 parts by weight of PCC (precipitate calcium carbonate) and GCC (grounded calcium carbonate) mixture, 6-10 parts of polystyrene-butadiene latex, 3-8 parts of conductive polymer (e.g., sodium salt of polystyrene sulfonates, etc.), and an effective amount of functional coating additives, such as color dye, OBA (optical brightness agent), viscosity controlling agents, water retaining agent and deformer. Pigment-containing layer 120 is formed on substrate 110 by coating the upper surface of substrate 110 to a coating weight of 8-12 gram/m² using a blade-pilot coater. A super-calender is used to provide a 60-70 percent gloss level as measured by a gloss meter at a 75-degree angle. Layer 140 has 100 parts of grounded calcium carbonate, 5-10 parts of polymeric binder, and 3-5 parts of polyethylene beads of 3-7 microns in diameter.

Image-receiving layer 130 may include a cross-linkable or self-cross-linkable polystyrenebutadiene copolymer latex and may also include a polyacrylic latex. A small amount of cure catalyst and polymeric wax particles with a mean particle diameter ranging from about 0.1 micron to about 1 micron for one example or about 0.3 micron to about 0.5 micron may also be included. The amount of the wax in image-receiving layer 130 is about 15 parts by weight to about 40 parts by weight based on 100 parts of dry weight of the polymer latex. The coat weight of image-receiving layer 130 was about 4 to about 5 gram/mm²

### Conclusion

Although specific embodiments have been illustrated and described herein it is manifestly intended that the scope of the claimed subject matter be limited only by the following claims and equivalents thereof.

What is claimed is:

1. A media sheet comprising:
a substrate;
a first layer formed on the substrate, the first layer comprising inorganic pigments; and
a second layer formed on the first layer and comprising a plurality of wax particles.

2. The media sheet of claim 1, wherein the second layer further comprises a resin.

3. The media sheet of claim 2, wherein the resin is selected from the group consisting of water-soluble resins and water-dispersible resins.

4. The media sheet of claim 1, wherein the inorganic pigments are selected from the group consisting of titanium dioxide, hydrated alumina, calcium carbonate, barium sulfate, silica, kaolin clays, zinc oxide.

5. The media sheet of claim 1, wherein the first layer further comprises binder.

6. The media sheet of claim 5, wherein the binder is selected from the group consisting of a water-soluble polymer and a water-dispensable polymeric latex having micron or submicron organic particles.

7. The media sheet of claim 1, wherein the wax particles are selected from the group consisting of carnauba wax, montan wax, paraffin wax, microcrystalline waxes from the distillation of crude oil, synthetic polymers, and combinations thereof.

8. The media sheet of claim 1 further comprises a third layer formed on a surface of the substrate opposite the second layer.

9. The media sheet of claim 8, wherein the third layer comprises second particles.

10. A media sheet comprising:
a substrate;
a first layer formed on the substrate, the first layer comprising inorganic pigments and a binder; and
an image-receiving layer formed on the first layer and comprising a plurality of wax particles dispersed in a resin.

11. The media sheet of claim 10, wherein the plurality of wax particles in the image-receiving layer is about 5 to about 50 percent of the dry weight of the resin in the image-receiving layer.

12. A method for forming a media sheet, comprising:
forming a first layer on a substrate, the first layer comprising inorganic pigments; and
forming a second layer on the first layer, the second layer comprising a plurality of wax particles.

13. The method of claim 12, wherein forming a first layer on a substrate comprises coating the substrate with a coating.

14. The method of claim 13, wherein the coating comprises a liquid containing the inorganic pigments and a binder.

15. The method of claim 12, wherein forming a second layer on the first layer comprises coating the first layer with a coating.

16. The method of claim 15, wherein the coating comprises a liquid containing the wax particles and a resin.

17. The method of claim 12 further comprises drying the first layer before forming the second layer thereon.

18. The method of claim 17 further comprises calendering the first layer after drying the first layer and before forming the second layer thereon.

19. A method of printing, comprising:
disposing marking material on an image-receiving layer of a media sheet;
wherein the image-receiving layer is formed on a pigment-containing layer of the media sheet; and
wherein the image-receiving layer comprises a plurality of wax particles and pigments of the pigment-containing layer are inorganic pigments.

20. The method of claim 19 further comprises fusing the marking material into the image-receiving layer.
